(19) United States
(12) Patent Application Publication
(10) Pub. No.: US 2006/0093356 A1
(43) Pub. Date: May 4, 2006

(54) Optical network that detects and removes Rogue ONTS

(76) Inventors: Jerry Darden Vereen, Coral Springs, FL (US); Iris Lopez, Miami, FL (US); Raul F. Fernandez, Miami, FL (US)

Correspondence Address: LAW OFFICES OF MARK C. PICKERING, P.O. BOX 300, PETALUMA, CA, 94953, US

(21) Appl. No.: 11/186,222

(22) Filed: Jul. 21, 2005

Related U.S. Application Data
(60) Provisional application No. 60/623,423, filed on Oct. 28, 2004.

(51) Int. Cl. H04B 10/08

(52) U.S. Cl. 398/33

(57) ABSTRACT

A point-to-multipoint communications network includes an optical line terminal (OLT) and a number of optical network terminals (ONTS) which each detect and remove rogue ONTs from the network. The OLT monitors transmission errors to detect the presence of a rogue ONT, and can determine the identity of the rogue. Each ONT monitors its own upstream data packets to detect the presence of a rogue, and turns itself off when a rogue is detected.

This application claims benefit from Provisional Application No. 60/623,423 filed on Oct. 28, 2004 for “Rogue ONT.”

### BACKGROUND OF THE INVENTION

1. Field of the Invention

The present invention relates to optical networks and, more particularly, to an optical network that detects and removes rogue ONTS.

2. Description of the Related Art

One type of passive optical network (PON) is a point-to-multipoint communications network. In a point-to-multipoint communications network, downstream data packets are transmitted from an optical line terminal (OLT) to a number of optical network terminals (ONT) that are located at or near a corresponding number of end users. Upstream data packets, on the other hand, are transmitted from the ONTs back to the OLT.

In operation, the OLT assigns a sequence of transmission timeslots to the ONTs that are connected to the OLT via a common fiber. During normal operation, the ONTs transmit data packets to the OLT during their assigned timeslots and only during their assigned timeslots.

One problem which can arise is when, due to a hardware or software failure, an ONT transmits at the wrong time. If a first ONT transmits during a time slot which has been assigned to a second ONT and both ONTs attempt to transmit at the same time, a collision results which can prevent the OLT from being able to receive the data packets output by either ONT.

Thus, for example, when the optical transmitter of an ONT “sticks on” and continuously transmits during all of the assigned time slots, none of the ONTs are able to successfully send complete data packets to the OLT. An ONT that transmits in the upstream direction during the wrong time slot, such as a continuously-transmitting ONT or an ONT that turns on and off at random intervals, is known as a “rogue ONT”.

Thus, in order to prevent a continuously-transmitting rogue ONT from incapacitating an entire a network segment, there exists a need for an optical network that can detect and remove a rogue ONT from the network.

### SUMMARY OF THE INVENTION

A method of detecting a rogue terminal in a network is disclosed according to an embodiment of the present invention. The network has a first terminal and a plurality of second terminals connected to the first terminal via an optical splitter. The data network is monitored, and checked to determine if network corruption is present. When network corruption is detected a rogue signal is output.

An optical line terminal is disclosed according to an embodiment of the present invention. The optical line terminal includes an optical transmitter that transmits data packets to terminals optically connected to a network, and an optical receiver that receives data packets from the terminals optically connected to the network. The optical line terminal also includes a microprocessor connected to the optical transmitter and the optical receiver that monitors the data network, and checks to determine if network corruption is present. When network corruption is detected a rogue signal is output.

An optical network terminal is disclosed according to an embodiment of the present invention. The optical network terminal includes a controller that outputs a series of data packets, and a corresponding series of first valid pulses; and an optical transceiver that receives the series of data packets, and a corresponding series of second valid pulses.

In addition, the optical network terminal also includes a logic device that receives the series of data packets and the corresponding series of first valid pulses, determines whether the series of data packets satisfy a transmission protocol, and outputs the series of second valid pulses when the transmission protocol has been satisfied.

A method of operating an optical network terminal that polices itself and halts upstream data transmission when a rogue is detected is disclosed according to an embodiment of the present invention. A series of data packets, and a corresponding series of first valid pulses are received. In addition, whether or not the series of data packets satisfy a transmission protocol is determined. Further, a series of second valid pulses are output when the transmission protocol has been satisfied. The second valid pulses indicate when the series of data packets are valid.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1A is a block diagram illustrating an example of a point-to-multipoint communications network 100 in accordance with the present invention. FIG. 1B is a block diagram illustrating an example of an optical line terminal (OLT) 110 in accordance with the present invention.

FIGS. 2A-2B are flow charts illustrating an example of a method 200 of operating an OLT in accordance with the present invention.

FIG. 3 is a flow chart illustrating an example of a method 300 of detecting network corruption in accordance with the present invention.

FIG. 4 is a flow chart illustrating a method 400 of identifying a rogue ONT in accordance with the present invention.

FIG. 5 is a diagram illustrating an alternate method 500 of identifying a rogue ONT in accordance with the present invention.

FIG. 6 is a block diagram illustrating an example of an ONT 116 in accordance with the present invention.

FIG. 7 is a flow chart illustrating a method 700 of operating an ONT 116 in accordance with the present invention.

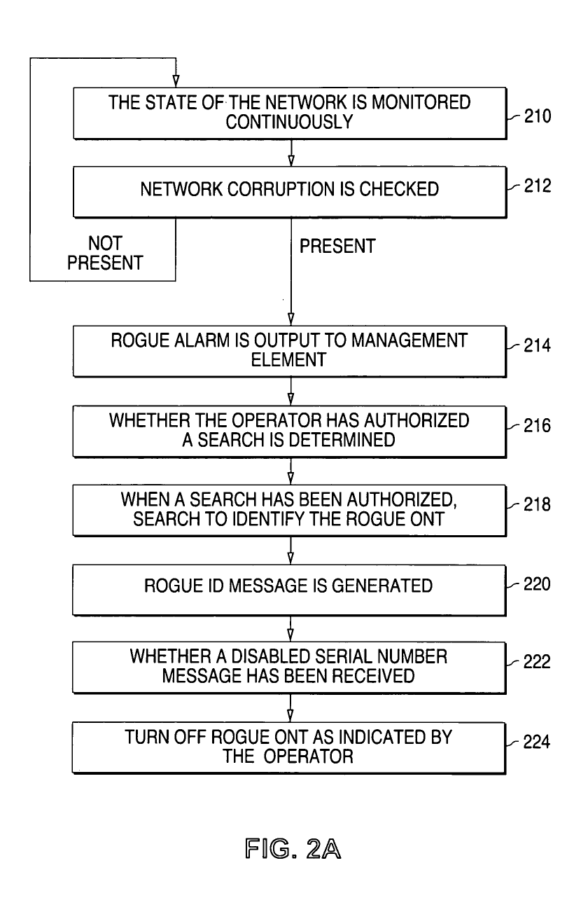

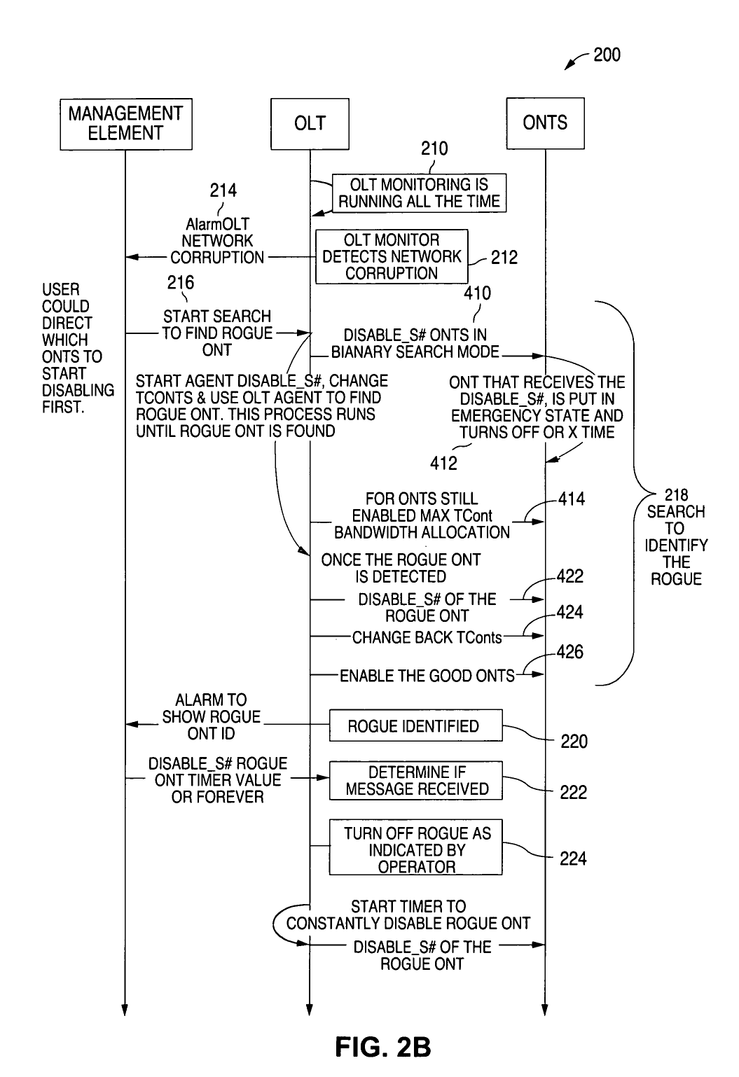

As noted, FIGS. 2A, 2B, 3, 4, and 7 are flow charts illustrating methods according to embodiments of the present invention. The techniques illustrated in these figures may be performed sequentially, in parallel or in an order other than that which is described. It should be appreciated that not all of the techniques described are required to be performed, that additional techniques may be added, and that some of the illustrated techniques may be substituted with other techniques.

### DETAILED DESCRIPTION OF THE INVENTION

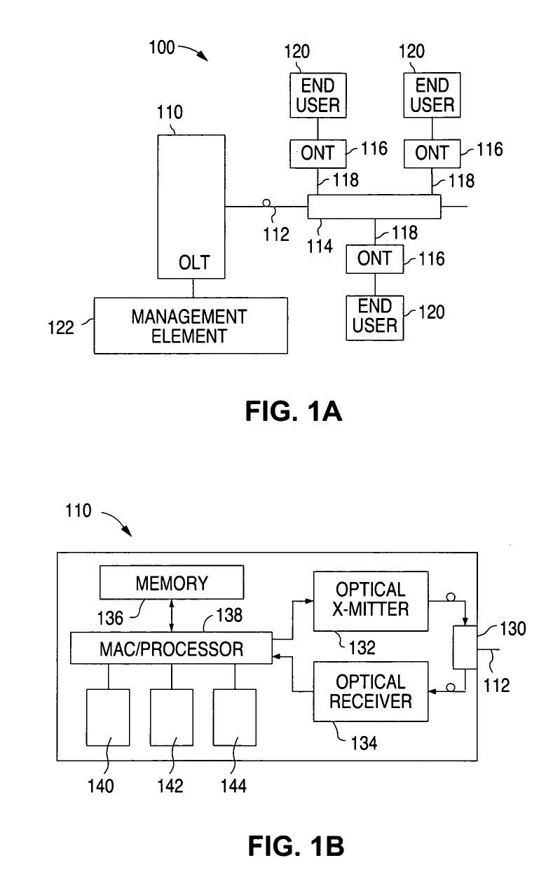

FIG. 1A shows a block diagram that illustrates an example of a point-to-multipoint communications network 100 in accordance with the present invention. As described in greater detail below, communications network 100 includes modified OLTs and ONTs which each detect and remove rogue ONTs from the network.

As shown in FIG. 1A, communications network 100 includes an optical line terminal (OLT) 110, a fiber optic cable 112, and a passive 1×N optical splitter 114 that is connected to OLT 110 via fiber optic cable 112. In addition, communications network 100 includes a number of optical network terminals (ONTs) 116, and a number of fiber optic cables 118 that connect optical splitter 114 to the ONTs 116. Each ONT 116, in turn, is connected to an end user 120.

Further, communications network 100 also includes a management element 122 that is connected to OLT 110. Management element 122 represents the operator interface to OLT 110, and can be configured in a variety of ways to provide operator alerts, status reports, automated functions, search options, and operator input.

In operation, management element 122 initially configures OLT 110. Once configured, OLT 110 establishes a sequence of transmission timeslots, and assigns the transmission timeslots to the ONTs 116 that are connected to fiber optic cable 112. During normal operation, the ONTs 116 transmit data packets to OLT 110 during their assigned timeslots and only during their assigned timeslots.

FIG. 1B shows a block diagram that illustrates an example of OLT 110 in accordance with the present invention. As shown in FIG. 1B, OLT 110 includes an interface unit 130 that is connected to cable 112, and an optical transmitter 132 that generates and outputs downstream data packets to the ONTs 116 via interface unit 130. Further, OLT 110 includes an optical receiver 134 that receives upstream data packets from the ONTs 116 via interface unit 130.

In addition, OLT 110 includes a memory 136, and a MAC/processor 138 that is connected to transmitter 132, receiver 134, and memory 136. Memory 136 stores the instructions and data required to operate MAC/processor 138. MAC/processor 138 outputs downstream data to optical transmitter 132, and receives upstream data from optical receiver 134.

OLT 110 also includes traffic corruption counters 140, churning (physical layer operation, administration, and maintenance (PLOAM)) corruption counters 142, and ranging error counters 144. The traffic corruption counters 140 can include, for example, a BIP8 counter that corresponds with each ONT, a discard cells counter that corresponds with the grant IDs, and an un-received cells counter that also corresponds with the grant IDs. Further, the churning corruption counters 142 and ranging error counters 144 correspond with the ONTs 116 such that, for each ONT 116, OLT 110 has a corresponding churning counter 142 and a corresponding ranging counter 144.

FIGS. 2A-2B show flow charts that illustrate an example of a method 200 of operating an OLT, such as OLT 110, in accordance with the present invention. As shown in FIGS. 2A-2B, method 200 begins at 210 where the state of the network is monitored continuously. In 212, network corruption is checked.

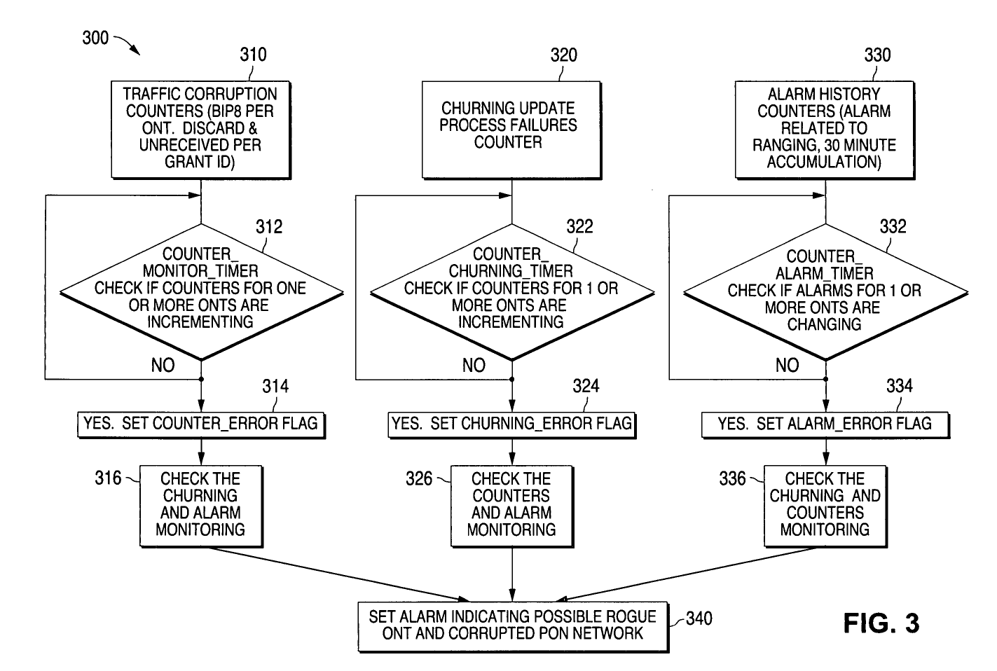

FIG. 3 shows a flow chart that illustrates an example of a method 300 of detecting network corruption in accordance with the present invention. In the present invention, the presence of a rogue ONT is inferred from the presence of network corruption. Further, method 300 can be executed by MAC/processor 138.

As noted above, during normal operation, an ONT 116 transmits data upstream to OLT 110. The presence of a rogue, however, causes a number of errors to occur in the upstream traffic patterns. OLT 110 monitors the errors, and reports any error events. For example, OLT 110 can count errors associated with receiving packets from the ONTs 116.

OLT 110 can then detect the likely presence of a rogue by determining whether errors have been reported for an ONT 116 during an accumulation period. The error reporting events which can be monitored by OLT 110 (and which are typically available through the OLTs software protocol stack (OLT monitor function)) include traffic corruption, churning (PLOAM) corruption, and ranging errors. Each event has a flag to show the corruption: a traffic corruption flag, a churning (PLOAM) corruption flag, and a ranging error flag. Method 300 can alert the user when any of the event flags are set.

With respect to traffic corruption, as shown in the FIG. 3 example, a number of traffic corruption counters, such as the traffic corruption counters 140, detect and count this condition in 310. In the present invention, the traffic corruption counters are monitored in 312 to determine if a counter has detected and counted a traffic corruption error for an ONT 116 during an accumulation period.

For example, the traffic corruption counters 140 can be implemented with the BIP8 error counters, the discard cells counters, and the un-received cells counters. The BIP8 counter shows corruption on the payload of the cell in a specific ONT. The counter increments when the BIP8 value calculated by the PON (OLT 110) differs from BIP8 value calculated by the ONT.

BIP8 calculation is based on the G.9831 standard. When this counter increments, the ONT needs to be ranged. The BIP8 counter may also increment when traffic containers (TConts) are added to the ONT. Therefore every time TConts are added, the BIP8 counter should be cleared. (Adding or removing TConts adds or removes bandwidth allocated to the ONT.)

The discard cells counter shows corruption on the cell headers. The discard cells counter increments on header error check (HEC) errors in the data cells. The counter also increments on bad PLOAM cell headers. When this counter increments, the ONT needs to be ranged. The counter is per grant identification (ID).

The un-received cells counter shows that an ONT is not answering in the allocated timeslot. The un-received cells counter increments when the PON (OLT 110) sends a grant to the ONT, but the ONT did not answer in the expected time. When this counter increments, the ONT needs to be ranged. The counter is per grant ID.

When in 312 it is determined that none of the traffic corruption counters have been incremented, then method 300 continues to check during the next accumulation period. On the other hand, when a traffic corruption counter has been incremented during an accumulation period, one indication has been met that a rogue is present, and a counter error flag is set in 314. When the counter flag is set, other error flags are checked in 316.

With respect to churning (PLOAM) corruption, as shown in the FIG. 3 example, a number of churning update failure counters, such as the churning corruption (update failure) counters 142, detect and count this condition in 320. (Churning is a security feature wherein a churn key is generated by an ONT and sent to an OLT.)

The churning corruption counters show that the churning messages are being corrupted, and increments when there are churning failures. In the present invention, the churning corruption counters are monitored in 322 to determine if a counter has detected and counted a churning update failure error for an ONT 116 during an accumulation period. When this counter increments, the ONT needs to be ranged. The counter is per ONT.

When in 322 it is determined that none of the churning corruption counters have been incremented, then method 300 continues to check during the next accumulation period. On the other hand, when a churning corruption (update failure) counter has been incremented during an accumulation period, one indication has been met that a rogue is present, and a churning error flag is set in 324. When the churning flag is set, other error flags are checked in 326.

The accumulation period for traffic and churning corruption is somewhat long, in the order of seconds, to allow for enough errors to be accumulated and counted. The time is affected by the amount of upstream bandwidth allocated to a particular ONT 116. ONTs 116 transmit in bursts and are granted the right to transmit by OLT 110 in real time. The more bandwidth allotted to an ONT 116, the more grants must be provided by OLT 110, and less time is required. Thus, the time to wait to accumulate errors could be lessened.

With respect to ranging errors, as shown in the FIG. 3 example, a number of ranging counters, such as the ranging counters 144, detect and count this condition in 330. In the present invention, the ranging counters are monitored in 332 to determine if a ranging counter has exceeded a predefined threshold during an accumulation period allotted for ranging.

Active, Deactivated, LCD, LOS, customer premises equipment (CPE), operation, administration, and maintenance layer (OAML), LOA, start up failure (SUF), Dying Gasp alarms and events can be recorded at the PON (OLT 110) for X period. The ranging counter provides history of the ranging alarms and the stability of the PON Network. The ranging counter is only interested in alarms on ONTs that actually ranged. If the ONT does not range in X period, method 300 can not determine if the ONT is physically connected to the PON network.

When in 332 it is determined that none of the ranging error counters have exceeded the predefined threshold, then method 300 continues to check during the next accumulation period. On the other hand, when a ranging counter has exceeded the predefined threshold during an accumulation period, one indication has been met that a rogue is present, and a ranging error flag is set in 334. When the ranging flag is set, other error flags are checked in 336.

In the present example, when the traffic corruption, churning corruption, and ranging error flags are set, an alarm is set in 340 indicating that a rogue ONT is likely present. In the FIG. 3 example, the three error reporting threads are monitored at the same time, and an alarm is only generated when all three flags have been set.

Although three error reporting threads have been described, any number of error reporting threads, including one, can be used to detect the likely presence of a rogue, depending on the reliability of the measure. Ranging errors are the worst type since data transmission is halted (service is down entirely) until the ONT is ranged. Other error types typically appear before ranging errors. So the decision to set the alarm in 340 may not want to wait until there are ranging problems, since it is more than likely other ONTs have been severely affected at this point.

Returning to FIGS. 2A-2B, if no network corruption is detected, method 200 returns to 210. On the other hand, if network corruption is detected, method 200 moves to 214 to output a rogue alarm to the network management element, such as management element 122. Thus, in the present example, if all three of the PON integrity indicators flags (the traffic corruption flag, the churning corruption flag, and the ranging flag) have been set, method 200 alerts the management element with a PON network corruption alarm. OLT 110 can autonomously output the PON network corruption alarm to management element 122.

If only one indicator is used to generate the rogue alarm, there are acceptable circumstances were the indicators values may increase, therefore the PON network corruption alarm also includes information about which integrity corruption flag was set. For example, a PON network corruption—traffic corruption alarm can mean that there were BIP8, discard, or un-received cell errors. This is a tip for the operator to start a search for a rogue ONT. However, if this is the only indicator being set it may also show, for example, that the fiber is dirty, or optical power is too high.

In addition, an operator can also use a statistics of the indicators counters message. In this message, the operator can request the indicator counters: BIP8, discard, un-received and churning failure. The operator can also request to clear these counters. Menu/items for the handling of a rogue ONT can include, for example, status of PON network, statistics of the indicators counters, and a search method.

As described below, the process of identifying a rogue effects service to all subscribers connected to network 100. As a result, OLT 110 provides status signals to the operator via management element 122 to warn the operator that service will be effected. In addition, OLT 110 provides control signals to the operator via management element 122 to allow the operator to initiate a search process (to identify the rogue), and pause and terminate the search process at any point.

For example, a start/stop detection message can be used to initiate a search if a PON network corruption event message has been received. This will be service affecting as the search will deactivate ONTs and change the TConts (allocated bandwidth). As described in greater detail below, the detection mechanism does a binary search for the rogue ONT which is service effecting. Because of this, the operator may select which set of ONTs to start the detection. The operator can also stop the search. This recovers the old configuration of the ONTs (TConts).

Thus, in the present invention, using generally available error monitoring routines, it is possible to detect the likely presence of a rogue ONT. After the rogue ONT has been detected, it is left to the network support personnel to decide whether or not to identify the rogue. OLT 110 reports the possibility of a rogue ONT to management element 122, and it is left up to the network operator to decide when to take further action.

Errors are counted on an ONT by ONT basis. There is really no way of knowing for sure if the errors counted for a particular ONT are due to a rogue. It could be that each of the ONTs that are counting errors are transmitting in their correct timeslots but are each just running errors for some other reason, not due to a rogue.

At some point the operator has to decide that more than one ONT is running errors and it could be a rogue condition. Checks to rule out other causes an optionally be included. Each of the ONT error counters are independent, and all running at the same time. The PON method by definition ensures that only one ONT transmits at a time. If there are accumulated errors from more than one ONT then it may be due to a rogue ONT.

Returning to FIGS. 2A-2B, once a rogue alarm has been generated and output, method 200 moves to 216 to determine if the operator has authorized a search to identify the rogue ONT. In 218, when a search has been authorized, method 200 searches to identify the rogue ONT.

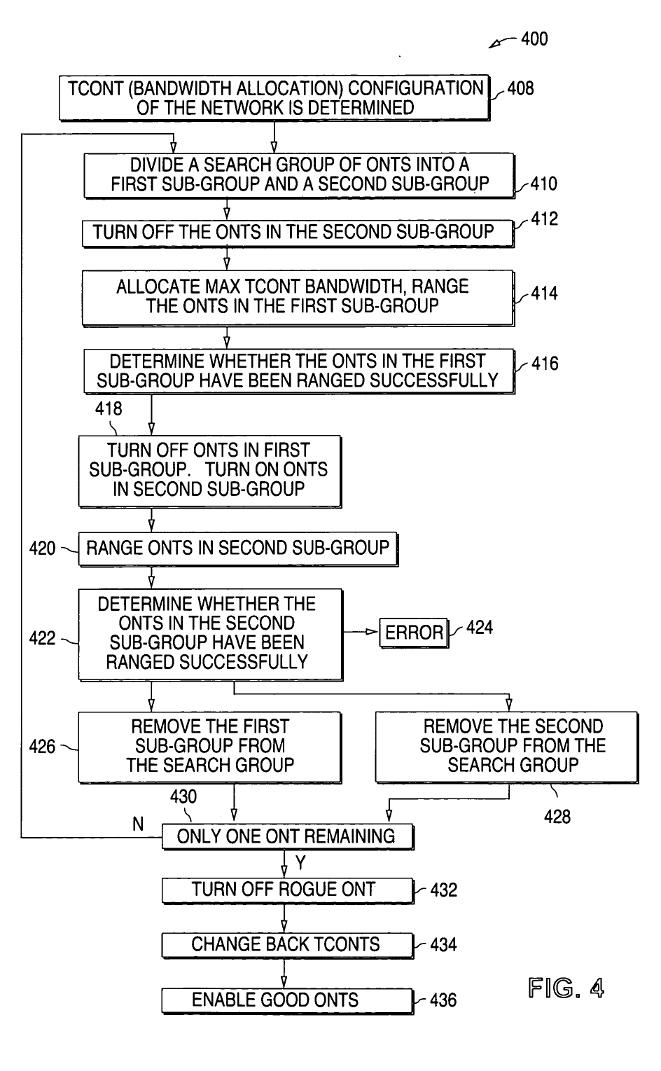

FIG. 4 shows a flow chart that illustrates a method 400 of identifying a rogue ONT in accordance with the present invention. Method 400 can be executed by MAC/processor 138. As shown in FIG. 4, method 400 begins in 408 where the TConts (allocated bandwidth) configuration of the network is determined. (Call API GetTContConfig for each ONT.) In 410, a search group of ONTs is divided into a first sub-group, such as the lowest ONT IDs, and a second sub-group, such as the highest ONT IDs.

Next, in 412, the ONTs in the second sub-group are turned off, starting the with the highest ONT ID. For example, if 32 ONTs are connected to a PON network, ONTs 1-16 can be placed in the first sub-group, while ONTs 17-32 can be placed in the second sub-group and turned off. The ONTs in the second sub-group can be turned off by sending the ONTs a Disable_Serial_Number message as defined by the ITU-T G.983.1 ATM Passive Optical Network Specification. Critical to the identification process is the ability to send a downstream message to an ONT when the ONT is not in the ranged state. This is necessary since it is well established that a rogue ONT can cause the PON to loose range.

The G.983.1 Disable_Serial_Number message can be defined as “all ONTs with this serial number are to enter the “Transmit Off” state (also referred to as the “Emergency” state). (Call API SendDisableSerialNumberMsg to each ONT in the set.) As defined in G.983.1, the ONT identified in the Disable_Serial_Number message is denied upstream access.

When the Disable_Serial_Number message is received by an ONT, the message forces the ONT into a “Transmit Off” state (upstream “Laser Off” or “Optical Transceiver Off” condition). Once the ONT forces its upstream laser to the “off” state following receipt of this message, two possible conditions for restart are possible.

In the first condition, the ONT can receive commands that allows for either group ONT re-enable or individual ONT re-enable using values 0x0F and 0x00 in octet 37, respectively. In this case, when it is time to turn an ONT back on, the commands needed for turn on are sent to the ONT. Thus, in this condition, the ONTs can be shut down and started back up in a controlled manner using the standard messaging defined in G.983.1.

In the second condition, the ONT can not respond to a subsequent message to turn back on after turning off in response to the G.983.1 Disable_Serial_Number message. In this case, the OLT sends the G.983.1 Disable_Serial_Number message multiple times to the same ONT. With each subsequent receipt of the message, the ONT takes on increased “off” time values. In this example, the ONT has a predefined time frame for receiving multiple messages before action is taken, after which the ONT would ignore further G.983.1 Disable_Serial_Number messages.

Alternately, the G.983.1 Disable_Serial_Number message can be modified such that the “off” time values are passed in octet 46 of the message. Currently, octet 46 is unspecified. Octet 46 would then contain a pointer to one of 256 “off” time values contained in a predefined table.

Returning to FIG. 4, after the second sub-group of the ONTs have been turned off, the TConts (allocated bandwidth) for the ONTs in the first sub-group are changed to a constant bit rate (CBR) in 414. The TConts need to be changed to CBR in order to bypass DBA. Further, the TConts are changed to occupy the whole grant map. The TConts are changed to increase the chances of catching a Rogue ONT overlapping a timeslot. (Call API DeleteTCont and AddTCont for each TCont in each ONT).

In addition, in 414, the ONTs in the first sub-group are ranged. For example, if ONTs 17-32 (the second sub-group) are placed in the “off” state, then the OLT attempts to range ONTs 1-16 (the first sub-group). In 416, method 400 determines whether the ONTs in the first sub-group have been ranged successfully and have no upstream errors for a predetermined period of time.

In 418, the OLT turns off the ONTs in the first sub-group, and turns on the ONTs in the second sub-group. Following this, in 420, the ONTs in the second sub-group (17-32) are ranged. In 422, method 400 determines whether the ONTs in the second sub-group have been ranged successfully and have no upstream errors for the predetermined period of time.

If both the first and second sub-groups were successfully ranged without upstream errors for the predetermined period of time, then in 424 an error is declared because both sub-groups can not successfully range with no upstream errors if a rogue is present. If the first sub-group was successfully ranged with no upstream errors in 416 and the second sub-group was not successfully ranged or had upstream errors in 422, then in 426 the OLT declares that the rogue is not in ONTs 1-16, and removes the first sub-group from the search group. On the other hand, if the first sub-group was not successfully ranged or had upstream errors in 416 and the second sub-group was successfully ranged with no upstream errors in 422, then in 428 the OLT declares that the rogue is not in ONTs 17-32, and removes the second sub-group from the search group. Attempting to range both sub-groups provides a more robust implementation as the presence of the rogue is confirmed rather than being assumed.

From 426 or 428, method 400 determines in 430 whether only one ONT remains in the search group. When multiple ONTs remain in the search group, method 400 returns to 410 to turn on the ONTs in the remaining sub-group (via a command or waiting for a timer to expire when multiple G.983.1 Disable_Serial_Number messages are sent) and again repeat the process, but this time with half as many ONTs in the search group.

The process continues until only one ONT remains in the search group. For each successive smaller group of ONTs in the “transmit off” state, the off timer value can decrease based on the ranging time needed to confirm the number of ONTs left in the “on” state. Thus, each successive sub-group is reduced in size by way of a binary search algorithm until the rogue is found. When only one ONT remains in the search group, the remaining ONT is the rogue. In this case, in 432, a Disable_Serial_Number message is sent to the rogue ONT to turn off the rogue ONT.

In 434, after the Disable_Serial_Number message has been sent, the TConts (allocated bandwidth) is returned to the pre-search state, with the exception of the bandwidth allocated to the rogue ONT. In 436, the remainder of the ONTs receive a turn on message which, following a wake-up protocol, return to normal operation.

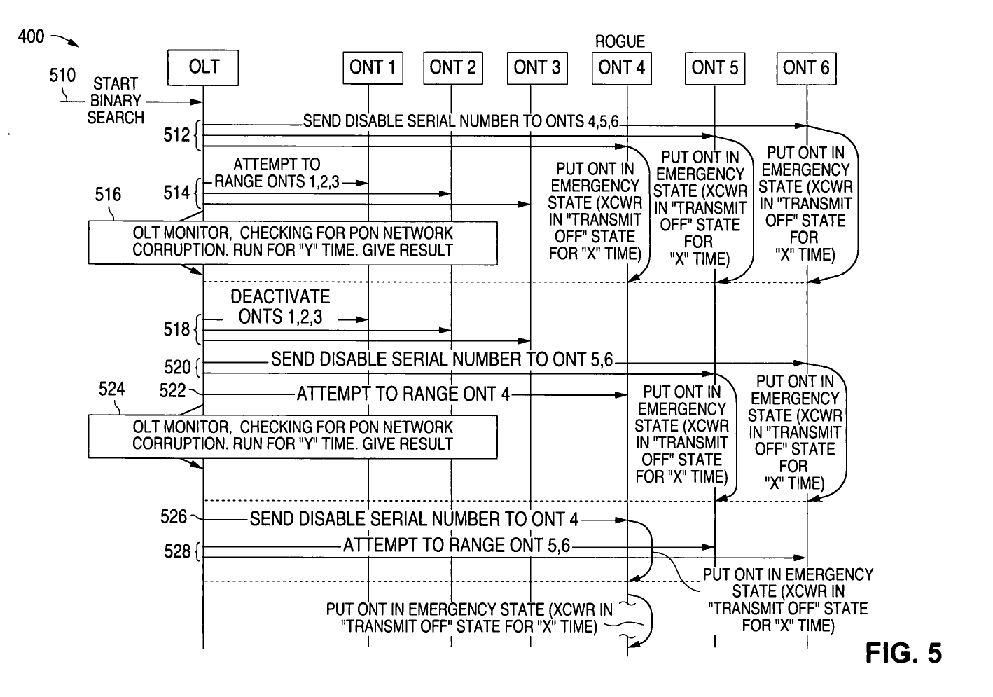

FIG. 5 shows a diagram that illustrates an alternate method 500 of identifying a rogue ONT in accordance with the present invention. As shown in FIG. 5, at 510, OLT 110 starts a binary search for the rogue ONT, which selects a search group that includes ONT1-ONT6. OLT 110 next assigns the group members to one of two sub-groups. For example, OLT 110 can start by placing the ONT that has the highest ID in the second sub-group, or with sub-groups given by the management element.

In the FIG. 5 example, ONT4-ONT6 are placed in the second sub-group and turned off at 512, while OLT 110 attempts to range ONT1-ONT3, which are placed in the first sub-group, at 514. At 516, it is determined whether the OLT monitor found any network corruption in ONT1-ONT3. When no corruption is found, OLT 110 deactivates ONT1-ONT3 (removes them from the search group) in 518, places ONT5-ONT6 in the next second sub-group, and ONT4 in the next first group.

OLT 110 turns off the members of the second sub-group, ONT5 and ONT6 in 520, and attempts to range ONT4 in 522. In 524, it is determined whether the OLT monitor found any network corruption in ONT4. When corruption is found, OLT 110 deactivates ONT4 in 526, and attempts to range ONT5-ONT6 in 528. If OLT 110 successfully ranges ONT5 and ONT6, ONT4 is defined to be the rogue.

Returning to FIGS. 2A-2B, at the end of the search, in 220, the rogue ONT has been identified, and a rogue ID alarm message is generated and output (by OLT 110) to the management element (e.g., 122) to identify the rogue ONT. In 222, method 200 determines whether or not a disable serial number message has been received from the management element.

Automatically or under operator control, the management element outputs a disable serial number message to the OLT instructing the OLT to remove the rogue from the network. The rogue can be removed for a predetermined period of time (perhaps hours) so a field technician could be dispatched to replace the unit, or forever.

Following this, in 224, when a message from the management element has been received, method 200 disables the rogue ONT, and starts a timer to constantly check and insure that the rogue ONT remains disabled, such as by continually outputting the Disable_Serial_Number message to the rogue ONT. In this case, a final G.983.1 Disable_Serial_Number message is sent to the rogue ONT, as necessary, to turn off the rogue ONT.

The operator can also attempt to manually search for a rogue ONT. For example, a power down ONT ID message can be used where the message turns off a specific ONT for a predetermined period of time (Toff). (Toff time is limited by the PLD at the ONT (see below), Toff is the maximum time that the ONT can be turn off)

In addition, the operator can also use a set/clear ONT to emergency state message. In this case, the user initiates a disable serial number message to a specific ONT. This may allow the operator to manually detect a rogue ONT. With the help of statistics from the indicators counters, the operator may manually trouble shoot the network for a Rogue ONT. (Power down of the ONT for Y time as a result of the Disable Serial Number message is limited by the PLD at the ONT). It does not start a search.

Method 400 assumes that a rogue ONT can receive messages from the OLT, and can act on the messages. In other words, the downstream direction must be functional to a point where the rogue is able to receive commands and execute the disable laser function. In the case where a rogue is unable to respond to downstream messages, each ONT in the present invention can also detect when it has become a rogue.

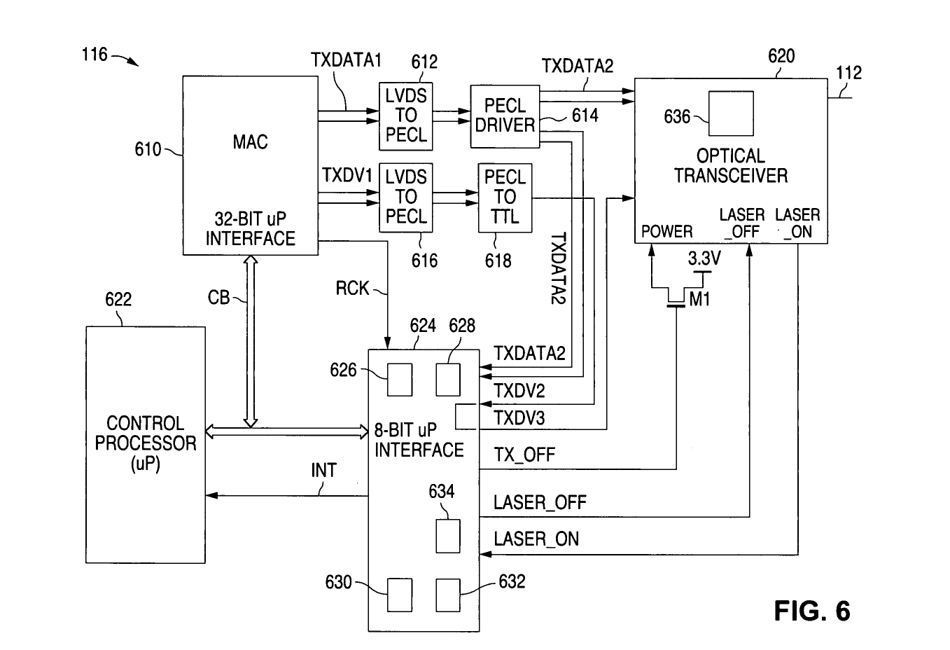

FIG. 6 shows a block diagram that illustrates an example of an ONT 116 in accordance with the present invention. As shown in FIG. 6, ONT 116 includes a media access controller (MAC) 610 that outputs a series of low-voltage data packets TXDATA1, and a corresponding series of low-voltage data valid pulses TXDV1 that indicate when the data packets TXDATA1 are valid. MAC 610 also recovers and outputs a recovered clock signal RCK, such as a 77.76 MHz clock signal.

In addition, ONT 116 includes a positive emitter coupled logic (PECL) data converter 612 that converts the low-voltage data packets TXDATA1 into PECL data packets TXDATA2, and a PECL driver 614 that drives the PECL data packets TXDATA2. ONT 116 further includes a PECL validation converter 616 that converts the low-voltage data valid pulses TXDV1 into PECL data valid pulses, and a PECL converter 618 that converts the PECL data valid pulses into TTL data valid pulses TXDV2. (PECL is a high-speed data transmission standard.)

As further shown in FIG. 6, ONT 116 includes an optical transceiver 620 that receives the series of PECL data packets TXDATA2, and a corresponding series of controlled data valid pulses TXDV3 that indicate when the data packets TXDATA2 are valid. Transceiver 620 further outputs a laser on signal LASER_ON that indicates when the laser driver is on, and receives a laser off signal LASER_OFF that commands transceiver 620 to turn off the laser driver. In this example, transceiver 620 also has a power input that receives 3.3V.

In addition, ONT 116 includes a control microprocessor 622 that is connected to MAC 610 via a 32-bit control bus CB. Microprocessor 622, which controls the operation of ONT 116 by, for example, loading transmission protocol data into MAC 610, also receives an interrupt signal INT.

In accordance with the present invention, ONT 116 further includes a programmable logic device (PLD) 624 that is connected to MAC 610, PECL drivers 614 and 618, optical transceiver 620, and microprocessor 622. As shown in FIG. 6, PLD 624 receives the clock signal RCK from MAC 610, and the PECL data packets TXDATA2 from PECL driver 614. PLD 624 also receives the PECL data valid pulses TXDV2 from driver 618, and outputs the controlled data valid pulses TXDV3.

Further, PLD 624 outputs a transceiver power control signal TX_OFF that, via a MOS transistor M1, controls the application and removal of power from the power input of transceiver 620. PLD 624 additionally outputs the laser off signal LASER_OFF, and the interrupt signal INT. PLD 624 also shares 8-bits of the 32-bit control bus CB.

PLD 624 further includes a number of protocol registers 626 that hold transmission protocol data that define, for example, the preamble, delimiter, minimum guard time of the data packets TXDATA1. PLD 624 also has a number of data valid registers 628 that hold pulse pattern data that define the data valid pulses TXDV1. PLD 624 additionally has a number of status registers 630 that indicate why an interrupt signal INT was generated.

Further, PLD 624 has a number of timers 632, which can be set in response to multiple receipts of the G.983.1 Disable_Serial_Number message, that select how long an ONT 116 or a group of ONTs 116 is to remain in the “off” state. The timer selection is important because, as noted above, the identification process involves placing a number of ONTs 116 in the “off” state while attempting to range the remaining ONTs 116. As a result, OLT 110 must wait for those ONTs 116 that entered the “off” state to exit from the “off” state after the timers 632 expire before OLT 110 can attempt to range again. It is a matter of time and efficiency in locating the rogue ONT.

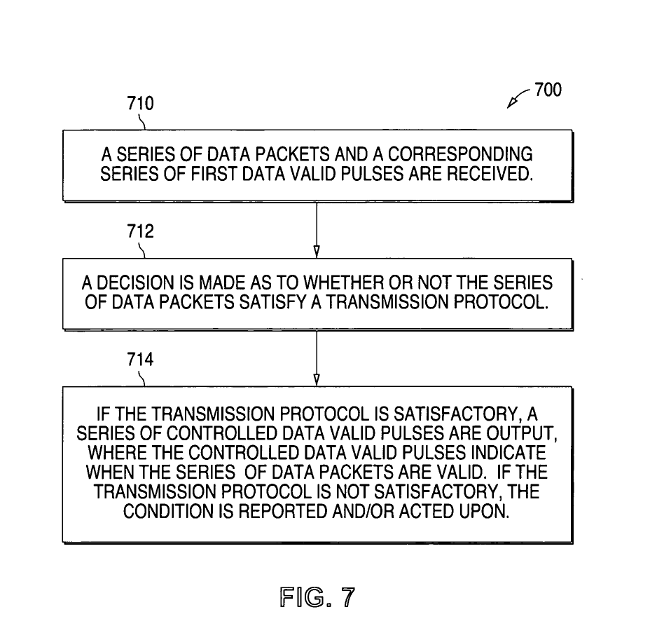

FIG. 7 shows a flow chart that illustrates a method 700 of operating an ONT 116 in accordance with the present invention. In method 700, ONT 116 polices itself and halts upstream data transmissions by forcing the transmission of a logic 0, turning off the laser, or powering off the optical transceiver.

As shown in FIG. 7, at 710 a series of data packets and a corresponding series of first data valid pulses, which indicate the validity of the data packets, are received by an ONT 116. At 712, a decision is made as to whether or not the series of data packets satisfy a transmission protocol.

In ONT 116, a single point failure in MAC 610 or microprocessor 622 can cause ONT 116 to begin functioning as a rogue, i.e., transmitting during the wrong time slot. In accordance with the present invention, PLD 624 monitors MAC 610 and microprocessor 622 to determine when a failure has occurred so that the optical transmitter can be shut down before or shortly after ONT 116 becomes a rogue.

At 714, if the transmission protocol is satisfactory, a series of controlled data valid pulses are output when the transmission protocol has been satisfied, where the controlled data valid pulses indicate when the series of data packets are valid. On the other hand, if the transmission protocol is not satisfactory, the condition is reported and/or acted upon.

In the case of MAC 610, PLD 624 can monitor, for example, the PECL data packets TXDATA2 that form the upstream data traffic and data valid (enable) pulses TXDV2 to determine whether the protocol characteristics of the transmission are being met. For example, PLD 624 can monitor the preamble, minimum guard time, and delimiter and, when compared to the predefined protocol stored in the protocol registers 626, determine whether MAC 610 is operating properly. The predefined protocol can be programmed into the protocol registers 626 in PLD 624 via control bus CB by microprocessor 622 so that PLD 624 has the same parameters that are programmed into MAC 610.

After being programmed, PLD 624 monitors every upstream cell, checking for the proper transmission of the preamble and delimiter. In this case, the exact pattern must match. PLD 624 also checks to insure that the minimum guard time is met for successive upstream transmissions.

In addition, microprocessor 622 can program the pulse pattern data into the pulse registers 628 of PLD 624 over control bus CB. After being programmed, PLD 624 monitors the data valid pulses TXDV2 and compares the pulses TXDV2 against the stored pulse pattern data and the overhead structure to ensure that the length of the data valid pulse matches one cell time.

If the preamble, delimiter, or guard time, or data valid pulse TXDV2 satisfy the predefined protocol, the controlled data valid pulses TXDV3 are output to transceiver 620. On the other hand, if the preamble, delimiter, or guard time, or data valid pulse TXDV2 is wrong, PLD 624 outputs the interrupt signal INT to microprocessor 622.

PLD 624 utilizes programmable thresholds for each condition that must be met in order to enter into a protection mode where the interrupt signal INT is output, or to exit from one and return to normal operation. Microprocessor 622 can then query the status registers 630 in PLD 624 via control bus CB to determine if the interrupt resulted from an overhead error or a data valid pulse error.

Microprocessor 622 can then attempt to repair the problem by reinitializing the registers in MAC 610 that control the preamble, delimiter, or guard time, or the data valid pulses TXDV1. If a repair is unsuccessful, or if microprocessor 622 opts not to attempt a repair, microprocessor 622 outputs a message to PLD 624 to shut down the optical transmitter.

PLD 624 can shut down the optical transmitter by asserting the laser off signal LASER_OFF which disables the laser driver. Alternately, PLD 624 can stop generating the controlled data valid signal TXDV3, thereby intercepting the data valid signal TXDV2. PLD 624 can additionally assert the power control signal TX_OFF to remove power from transceiver 620. Power can also be controllably removed from the transmit laser.

In the case of monitoring microprocessor 622, PLD 624 includes a board-level watchdog circuit 634 that exchanges messages with microprocessor 624 via control bus CB to ensure that microprocessor 624 has not failed. A malfunctioning microprocessor can cause a variety of problems that may go unnoticed when only monitoring the preamble, delimiter, or guard time, or the data valid signal TXDV2.

When a failure is detected by watchdog circuit 634, PLD 624 no longer outputs the interrupt signal INT and waits for instruction from microprocessor 622, but instead shuts down the optical transmitter using one of the methods described above if the preamble, delimiter, or guard time, or data valid pulse TXDV2 is wrong. Thus, PLD 624 acts independently, shutting down the optical transmitter when a potential rogue condition has been detected. (PLD 624 can also be programmed to act independently even if microprocessor 622 is operating properly.)

The watchdog circuit 634 of the present invention is an enhancement to the software watchdog typically provided as a software monitor for microprocessors. A software watchdog only resets the board based on “lost” code, while the watchdog circuit 634 of the present invention allows PLD 624 to make decisions if the watchdog conditions are not met.

In addition to MAC 610 and microprocessor 622, a single point failure in optical transceiver 620 can cause ONT 116 to begin functioning as a rogue, i.e., transmitting during the wrong time slot. In accordance with the present invention, optical transceiver 620 includes streaming detection logic 636 that monitors the optical transmission. For example, streaming detection logic 636 can ensure that the output laser is not continuously on, and/or that transmissions do not exceed one cell time. This protects the PON at the closest point to the physical layer interface.

One of the advantages of the present invention is that if a rogue ONT 116 automatically enters the “off” state by way of its own self policing (e.g., PLD 624 and logic 636), the need to disrupt service to search for the rogue is eliminated. This is because the rogue ONT will appear as a unit that has dropped out of range.

In addition, the upstream error monitoring in OLT 110 would indicate that errors had been present, or that there had been ranging problems. However, now that the rogue ONT has entered the “off” state, the errors have stopped. OLT 110 will either recover, or reranged the ONTs (all except the rogue) and resume normal operation.

Embodiments of the present invention may be provided as a computer program product, or software, that may include an article of manufacture on a machine accessible or machine readable medium having instructions. The instructions on the machine accessible or machine readable medium may be used to program a computer system or other electronic device.

The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment.

The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

It should be understood that the above descriptions are examples of the present invention, and that various alternatives of the invention described herein may be employed in practicing the invention. Thus, it is intended that the following claims define the scope of the invention and that structures and methods within the scope of these claims and their equivalents be covered thereby.

What is claimed is:

1. A method of detecting a rogue terminal in a network, the network having a first terminal and a plurality of second terminals connected to the first terminal via an optical splitter, the method comprising:
monitoring the data network; and
checking to determine if network corruption is present; and
outputting a rogue signal when network corruption is detected.

2. The method of claim 1 wherein network corruption is determined by counting errors associated with receiving data packets at the first terminal from the second terminals during an accumulation period.

3. The method of claim 2 wherein a rogue signal is output when an error is counted for a second terminal during the accumulation period.

4. The method of claim 2 wherein a rogue signal is output when a plurality of types of errors have been counted for a second terminal during an accumulation period.

5. The method of claim 2 wherein a rogue signal is output when an error is counted for more than one second terminals during the accumulation period.

6. The method of claim 2 wherein a rogue signal is output when a plurality of types of errors have been counted for more than one second terminals during an accumulation period.

7. The method of claim 6 wherein the plurality of types of errors being counted by said more than one second terminal during the predefined time are identical.

8. The method of claim 1, further comprising:
forming a search group that includes all of the second terminals that are connected to the first terminal via the optical splitter after the rogue signal has been output;
dividing the search group into a first sub-group and a second sub-group;
turning off the second terminals in the second sub-group;
ranging the second terminals in the first sub-group; and
determining whether the second terminals in the first sub-group were successfully ranged.

9. The method of claim 8 wherein the second terminals are turned off in response to receiving a turn off message.

10. The method of claim 9 wherein the turn off message is sent one time when a receiving second terminal can respond to a subsequent enable message.

11. The method of claim 9 wherein the turn off message is sent multiple times, a second terminal receiving multiple turn off messages within a predefined time period enters a timed shut down where a length of the timed shut down is based on the number of turn off messages that were received during the predefined time period.

12. The method of claim 9 wherein the turn off message is sent to a second terminal in an unused octet, the second terminal that receives a turn off message in the unused octet entering a timed shut down where a length of the timed shut down is based on information included in the unused octet.

13. The method of claim 8, further comprising changing a bandwidth allocation of the second terminals in the first sub-group to a constant bit rate.

14. The method of claim 8, further comprising:
turning off the second terminals in the first sub-group;
turning on the second terminals in the second sub-group;
ranging the second terminals in the second sub-group;
determining whether the second terminals in the second sub-group were successfully ranged.

15. The method of claim 14, further comprising:
removing the first sub-group from the search group to form a modified search group when the second terminals in the first sub-group were successfully ranged;
removing the second sub-group from the search group to form the modified search group when the second terminals in the second sub-group were successfully ranged; and
determining if only one second terminal remains in the modified search group.

16. The method of claim 15 wherein when only one second terminal remains in the modified search group, the one remaining second terminal is a rogue and is turned off.

17. The method of claim 15 wherein when a plurality of second terminals remain in the modified search group:
dividing the modified search group into a third sub-group and a fourth sub-group;
turning off the second terminals in the fourth sub-group;
ranging the second terminals in the third sub-group; and
determining whether the second terminals in the third sub-group were successfully ranged.

18. An optical line terminal comprising:
an optical transmitter that transmits data packets to terminals optically connected to a network;
an optical receiver that receives data packets from the terminals optically connected to the network;
a microprocessor connected to the optical transmitter and the optical receiver, the microprocessor:
monitoring the data network; and
checking to determine if network corruption is present; and
outputting a rogue signal when network corruption is detected.

19. An optical network terminal comprising:
a controller that outputs a series of data packets, and a corresponding series of first valid pulses;
an optical transceiver that receives the series of data packets, and a corresponding series of second valid pulses; and
a logic device that receives the series of data packets and the corresponding series of first valid pulses, determines whether the series of data packets satisfy a transmission protocol, and outputs the series of second valid pulses when the transmission protocol has been satisfied.

20. A method of operating an optical network terminal that polices itself and halts upstream data transmission when a rogue is detected, the method comprising:
receiving a series of data packets, and a corresponding series of first valid pulses;
determining whether the series of data packets satisfy a transmission protocol; and
outputting a series of second valid pulses when the transmission protocol has been satisfied, the second valid pulses indicating when the series of data packets are valid.
